(19) United States
(12) Patent Application Publication
(10) Pub. No.: US 2022/0053852 A1
(43) Pub. Date: Feb. 24, 2022

(54) SMART MASK

(71) Applicant: LASHEVAN KOREA CO., LTD, Changwon-si (KR)

(72) Inventor: Kyoung Su Baek, Gyeongsangnam-do (KR)

(21) Appl. No.: 16/997,271

(22) Filed: Aug. 19, 2020

(51) Int. Cl. A41D 13/11; A41D 31/10; A41D 31/30; A41D 31/02

(52) U.S. Cl. CPC A41D 13/1192; A41D 31/10; A41D 31/305; A41D 13/1161; A41D 2400/36; A41D 2500/10; A41D 31/02

(57) ABSTRACT

A smart mask is proposed, which combines a virus protection function with a sweat-absorbing and quick-drying function, an antibacterial and deodorizing function, and a skin care function. The smart mask includes an outer covering fabric of a three-ply fabric structure including an outside fabric, an inside fabric, and an intermediate fabric intersecting and knitting between the outside fabric and the inside fabric; and an inner covering fabric obtained by coating and drying a composition on a first surface thereof, the composition containing a water-repellent agent for fiber, a functional microcapsule obtained by micro-encapsulating functional oil that has antibacterial and deodorizing effects or skin care effects, and an aqueous binder for processing a fabric, the inner covering fabric being joined to the outer covering fabric by attaching a second surface of the inner covering fabric to a surface of the inside fabric.

### BACKGROUND OF THE INVENTION

### Field of the Invention

The present invention relates to a smart mask that combines a virus protection function with a sweat-absorbing and quick-drying function, an antibacterial and deodorizing function, and a skin care function.

### Description of the Related Art

Since most of virus protection masks that are widely used in the market in recent years are disposable masks, such as KF80 or KF94, which are sold in a pharmacy, it may be difficult to effectively supply the masks in response to sharply increasing demand due to the rapid spread of viruses. Particularly, the masks are problematic in that they may not be continuously used because the masks are contaminated or lose their filter functions after they are used several times, in view of the nature of the disposable masks.

Furthermore, in the case of coughing or sneezing while wearing the mask, an inner surface of the mask may be stained with secretions, or in the case of talking or simply breathing, moisture may be accumulated on the inner surface of the mask, thus giving an unpleasant feeling to a wearer.

Particularly, since most of the virus protection masks are disposable, the masks should be discarded or replaced with new ones when the masks are stained with secretions and soaked with moisture. Thus, this undesirably leads to the waste of resources.

### Documents of Related Art

(Patent Document 1) KR 10-1228704 (Jan. 25, 2013)

(Patent Document 2) KR 10-1563040 (Oct. 19, 2015)

(Patent Document 3) KR 10-2069880 (Jan. 17, 2020)

### SUMMARY OF THE INVENTION

The present invention has been made in order to solve the above-mentioned problems in the related art and an objective of the present invention is to provide a smart mask that has a virus protection function, may be repeatedly used through washing, and rapidly discharges secretions and moisture caused by sneezes or repeated breathing when worn, thus maintaining a comfortable wearing environment.

In order to achieve the objective of the present invention, the present invention provides a smart mask, including an outer covering fabric of a three-ply fabric structure including an outside fabric, an inside fabric, and an intermediate fabric intersecting and knitting between the outside fabric and the inside fabric; and an inner covering fabric obtained by coating and drying a composition on a first surface thereof, the composition containing a water-repellent agent for fiber, a functional microcapsule obtained by micro-encapsulating functional oil that has antibacterial and deodorizing effects or skin care effects, and an aqueous binder for processing a fabric, the inner covering fabric being joined to the outer covering fabric by attaching a second surface of the inner covering fabric to a surface of the inside fabric.

The intermediate fabric may include a first intermediate fabric and a second intermediate fabric that intersect with each other in a zigzag fashion to be knitted between the outside fabric and the inside fabric.

All of the outside fabric, the inside fabric, and the intermediate fabric of the outer covering fabric may be formed of synthetic microfiber, and the inner covering fabric may be formed of natural microfiber.

The natural fiber may be Tencel™ or rayon.

The functional microcapsule may include a phytoncide microcapsule obtained by micro-encapsulating phytoncide oil, a wasabi microcapsule obtained by micro-encapsulating wasabi oil, and a skin care microcapsule obtained by micro-encapsulating oil in which a component effective for skin care is dissolved.

The functional microcapsule may essentially include at least one of the phytoncide microcapsule and the wasabi microcapsule.

An uncoating channel of a predetermined width may be formed on a surface of the inner covering fabric to define a boundary between neighboring coating cells that are distributed on a plane due to coating and drying treatment of the composition, so that each of the coating cells may form a water repellent part and the uncoating channel may form a water absorbing part.

As described above, a smart mask according to the present invention is configured such that an inner covering fabric is added to an outer covering fabric of a three-ply fabric structure, thus forming a filter layer with a four-ply sectional structure, and thereby giving a virus protection function to the mask and allowing the mask to be repeatedly used through washing. Particularly, as a water-repellent agent for fiber is coated onto a surface of the inner covering fabric, moisture can be rapidly absorbed and discharged, so that a comfortable wearing environment can be maintained. In addition, as a functional microcapsule is coated onto the surface of the inner covering fabric, antibacterial and deodorizing effects and/or skin care effects can also be achieved. Particularly, since the functional microcapsule has a so-called sustained release effect that gradually releases a functional material, the mask can continuously show the above-described effects even if the mask is repeatedly washed and used several times.

### BRIEF DESCRIPTION OF THE DRAWINGS

The above and other objectives, features, and other advantages of the present invention will be more clearly understood from the following detailed description when taken in conjoint with the accompanying drawings, in which:

FIG. 1 is a front view showing a folded state of a smart mask according to an embodiment of the present invention;

FIG. 2 is a front view showing an unfolded state of the smart mask of FIG. 1;

FIGS. 3 and 4 are a side view and a front view showing a state of wearing the smart mask of FIG. 1;

FIG. 5 is an enlarged sectional view schematically showing a fabric structure of the smart mask according to the embodiment of the present invention;

FIG. 6 shows mask performance test results of an outer covering fabric of FIG. 5;

FIG. 7 is a 1,000× magnification photograph showing a wasabi microcapsule that is one component of a composition coated onto an inner covering fabric of FIG. 5;

FIG. 8 is a 500 to 20,000× magnification photograph before and after the wasabi microcapsule of FIG. 7 is coated onto the inner covering fabric of FIG. 5;

FIG. 9 is an enlarged view showing a state where moisture is sprayed onto the inner covering fabric of FIG. 5 coated with the composition;

FIG. 10 shows sweat-absorbing and quick-drying test results of the inner covering fabric of FIG. 9 (direction from an inside to an outside);

FIG. 11 shows sweat-absorbing and quick-drying test results of the inner covering fabric of FIG. 9 (direction from the outside to the inside); and

FIG. 12 shows test results of antibacterial activity after the inner covering fabric of FIG. 9 is washed.

### DETAILED DESCRIPTION OF THE INVENTION

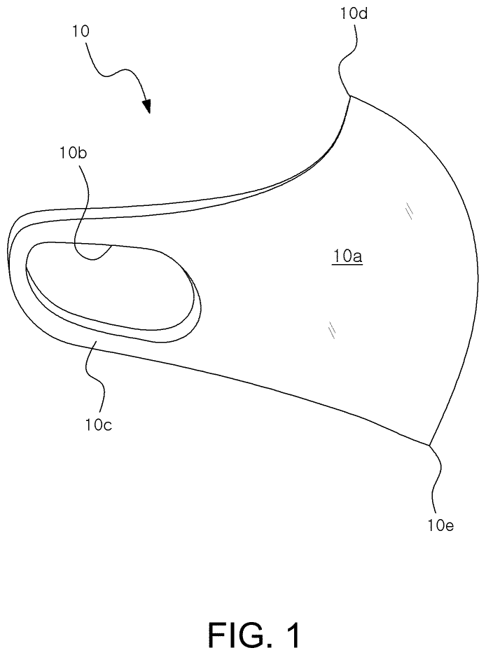

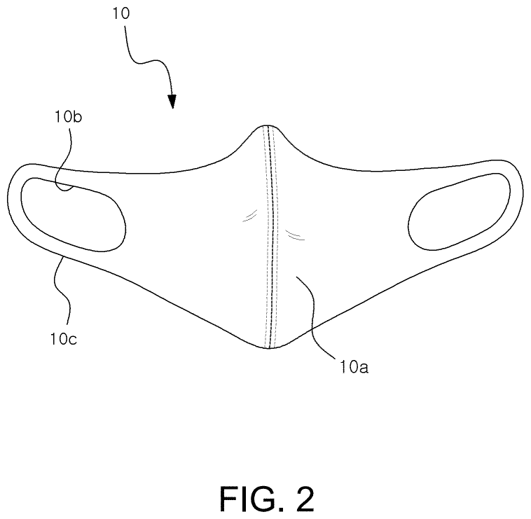

As shown in FIGS. 1 and 2, a smart mask 10 according to an embodiment of the present invention includes a central facial part 10a that extends in a horizontal direction to cover a wearer's nose, mouth, and both cheeks, a pair of left and right ear insert holes 10b formed through a fabric on both ends of the fabric which extend leftwards and rightwards from the facial part 10a, and a pair of left and right ear-hanging strings 10c forming outer peripheries of the ear insert holes 10b, respectively.

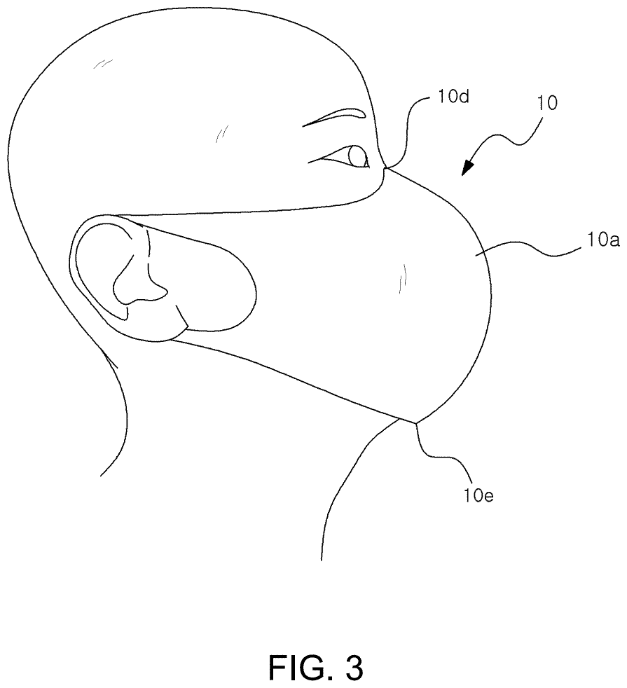

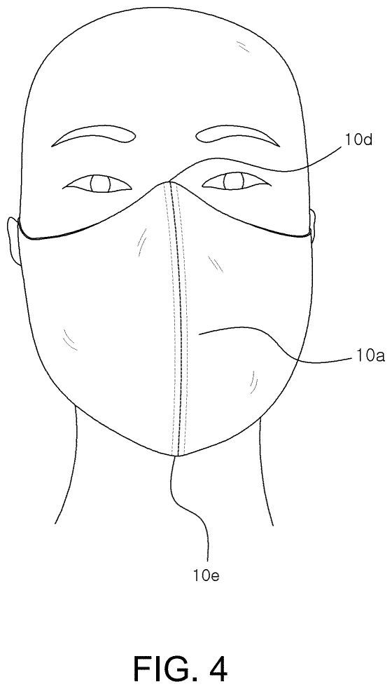

FIGS. 3 and 4 show the state of wearing the smart mask 10. An upper end 10d (see FIG. 1) extends upwards along a central line of the facial part l0a having a bilateral symmetrical structure to completely cover a wearer's nasal bridge, and a lower end 10e (see FIG. 1) extends downwards to a bottom of the wearer's chin to completely cover the chin. Such a shape of the facial part 10a prevents the mask 10 from being easily taken off, and allows an edge of the mask to come into close contact with the face, thus preventing external air containing viruses from being introduced through a gap.

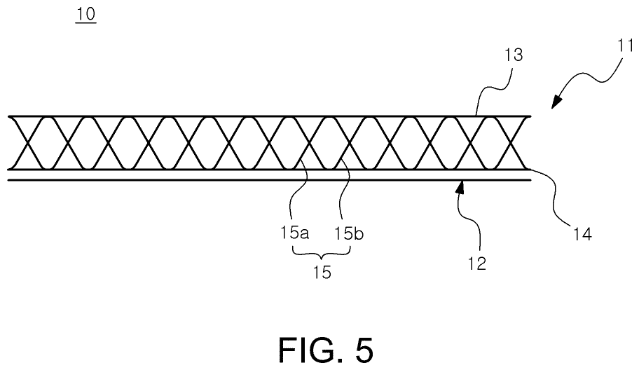

As shown in FIG. 5, the smart mask 10 has a layered structure formed by integrally attaching an outer covering fabric 11 and an inner covering fabric 12 via an adhesive. Here, the outer covering fabric 11 is a three-ply fabric structure formed by intersecting and knitting an intermediate fabric 15 between an outside fabric 13 and an inside fabric 14. Particularly, the intermediate fabric 15 is composed of a first intermediate fabric 15a and a second intermediate fabric 15b which intersect with each other in a zigzag fashion to be knitted between the outside fabric 13 and the inside fabric 14, thus improving a filter function.

Preferably, all of the outside fabric 13, the inside fabric 14, and the intermediate fabric 15 forming the outer covering fabric 11 are formed of microfiber. Preferably, the inner covering fabric 12 is likewise formed of microfiber. In addition, given that the inner covering fabric is in direct contact with the skin, the inner covering fabric is made of natural fiber so as not to cause skin problems. By way of example, Tencel™, rayon, etc. may be employed.

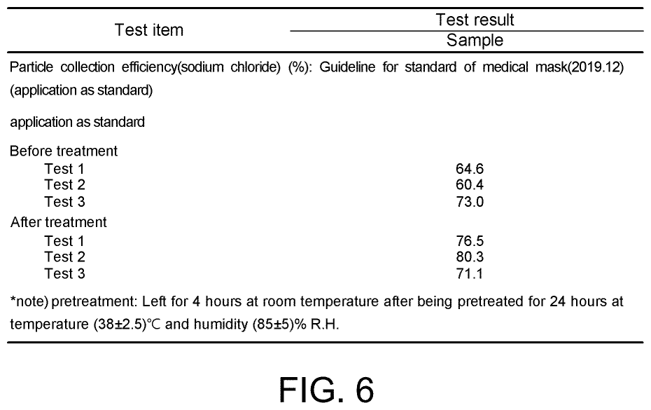

FIG. 6 shows a performance test for a knitted fabric having the outer covering fabric 11 of the above-described three-ply fabric structure. It can be seen that particle collection efficiency is distributed in the range of 60.4 to 80.3%. By adding the inner covering fabric 12 to the outer covering fabric (consequently, a four-ply structure is obtained), the particle collection efficiency may be further increased. As a result, the standard of KF80 (i.e. collection efficiency of 80% or more) may be sufficiently achieved.

Meanwhile, the inner covering fabric 12 (see FIG. 5) forming the smart mask according to the embodiment of the present invention uses a product made by coating a composition having a sweat-absorbing and quick-drying function and an antibacterial and deodorizing function onto a bottom of the fabric, drying the fabric, and then cutting the fabric.

The composition contains a water-repellent agent for fiber so as to realize the antibacterial and deodorizing function, and wasabi oil so as to realize the antibacterial and deodorizing function. Particularly, in the case of the wasabi oil, it is treated by a sustained release microcapsule so as to maintain the persistence of the antibacterial and deodorizing effect. Even in the case of the water-repellent agent for fiber, it is partially treated by the sustained release microcapsule to maintain the persistence of water-repellent performance.

Meanwhile, a water-repellent agent such as silicon, fluorine, or a surfactant for treating fiber is a material that increases a contact angle with water to control the absorption of water.

The fluorine-based water-repellent agent is the most commonly used water-repellent agent. Particularly, the fluorine-based water-repellent agent has the properties of simultaneously obtaining water repellency and oil repellency. The silicon-based water-repellent agent is less functional than the fluorine-based water-repellent agent but has a soft texture, so that the silicon-based water-repellent agent is widely used for cotton polymer, blended fabric, etc. However, the water-repellent agent is very sensitive to pH. Generally, this is rapidly deteriorated in water-repellent function, at pH 9 or more and at pH 4 or less.

Water repellency using a fluoro alkylacrylated phosphorous ester co-polymer, for example, as the fluorine-based water-repellent agent among the above-described water-repellent agents was widely used in the past. The present invention is intended to maximize functional effects by primarily micro-encapsulating silicon- or fluorine-based water-repellent agent, and subsequently using the water-repellent agent that has been subjected to the micro-encapsulation process and an existing water-repellent agent in combination.

In other words, a coating solution for water-repellent finishing containing the sustained release microcapsule is coated onto a general fabric in a predetermined pattern, thus processing a smart sweat-absorbing and quick-drying fiber. The water-repellent-agent microcapsule processed as such and the wasabi antibacterial microcapsule may be mixed with an aqueous binder for processing fiber, and then the mixture may be coated and printed on a commercial fabric.

Here, the water-repellent-agent microcapsule may be used within 50% of a total mixture. More preferably, about 10 to 40% is suitable. When the water-repellent-agent microcapsule is 10% or less, it is difficult for the microcapsule to function properly. Meanwhile, when the water-repellent-agent microcapsule is 40% or more, the content of the microcapsule is too high, so that performance may be deteriorated due to deterioration of fiber adhesion and vulnerability to external shock of the capsule.

The wasabi microcapsule is preferably within 10% of a total mixture. When the content of the wasabi microcapsule is too small, antibacterial properties may be deteriorated. In contrast, when the content of the wasabi microcapsule is too large, this may cause an unpleasant feeling due to the peculiar smell of the wasabi oil.

The content of the silicon-based or fluorine-based water-repellent agent that is not treated by the microcapsule is preferably 5 to 20%.

The above-described mixed compounds and an aqueous acrylic or urethane binder for processing fabric are used together, thus enhancing fiber adhesion. The microcapsule has a particle shape. Such a particle-shaped microcapsule should be physically attached to the fabric using the binder to ensure durability. Here, examples of the binder used together may include various binders, such as aqueous acrylic or urethane binders. After the process is performed on fabric, the binder that maintains sufficient adhesion to fiber and is excellent in washing resistance may be selected and used.

When mixed, an aqueous penetrant may be added to increase the fiber penetrability, the fiber adhesion, and the durability of the mixture if necessary. For example, DYNOL 960 commercially available from Air Product Inc. may be used. Such a penetrant is not an essential additive, and may control whether to use or not and adjust the kind of agents depending on the fiber surface and the finishing process. Generally, this is used in the range of 0.1% to 1% of a total mixture.

A method of manufacturing the composition containing the above-described components and having the sweat-absorbing and quick-drying function and the antibacterial and deodorizing function is as follows.

1. Micro-Encapsulation Process

(1) Emulsification Process of Fluorine-Based Water-Repellent Agent

50 g of Scripset 520 (Solenis Inc.) is dispersed into 950 g of water. 8 g of sodium hydroxide is added and then is gradually heated to 90 degrees. Subsequently, this is completely dissolved while maintaining the temperature for about 30 minutes. Subsequently, this is cooled and stored at room temperature.

500 g of Scripset 520 dissolved solution prepared as such is put into a 2 liter container/beaker. At this time, the rotating speed is maintained at about 800 rpm using a high-speed homomixer. 250 g of the fluorine-based water-repellent agent, e.g., fluoro alkylacrylated phosphorous ester co-polymer is gradually added to the dissolved solution for about 10 minutes. After the fluorine-based based water-repellent agent has been completely added, the stirring speed of the homomixer is increased to 1200 to 1700 rpm, thus performing emulsification.

(2) Emulsification Process of Wasabi Oil

50 g of Scripset 520 (Solenis Inc.) is dispersed into 950 g of water. 8 g of sodium hydroxide is added and then is gradually heated to 90 degrees. Subsequently, this is completely dissolved while maintaining the temperature for about 30 minutes. Subsequently, this is cooled and stored at room temperature.

500 g of Scripset 520 dissolved solution prepared as such is put into a 2 liter container/beaker. At this time, the rotating speed is maintained at about 800 rpm using a high-speed homomixer. 25 g of the wasabi oil and 225 g of soybean oil (oil quantity: 250 g) are gradually added to the dissolved solution for about 10 minutes.

After the wasabi oil and the soybean oil have been completely added, the stirring speed of the homomixer is increased to 1200 to 1700 rpm, thus performing emulsification.

(3) Composition and Preparation of Melamine Initial Condensation Polymer

125 g of water is put into a 500 ml beaker. 50 g of formalin 35%, 70 g of melamine powder, and 7 g of urea are added to the water. While the mixture is thoroughly stirred, temperature is gradually increased. The mixture is heated for about 10 to 15 minutes while being stirred until the temperature reaches about 60 degrees.

(4) Micro-Encapsulation of Water-Repellent Agent

The prepared melamine initial condensation polymer is put into an emulsification reactor of the fluorine-based water-repellent agent that is previously prepared. Subsequently, temperature is increased up to 70 degrees while the rotating speed is maintained at 1200 rpm or more.

At this time, a sufficient stirring state should be maintained while preventing viscosity from increasing as reaction progresses. After about one hour, the homomixer is removed, the temperature is maintained using a common stirrer, the rotating speed is maintained at 500 to 1000 rpm, and the stirring operation is continued for five hours or more.

Subsequently, the heating operation is stopped and 30 g of 5% citric acid solution is gradually added. Stirring is continued until the temperature reaches room temperature.

The water-repellent-agent microcapsule (see FIG. 1) produced as such is stored and used.

(5) Micro-Encapsulation of Wasabi Oil

The prepared melamine initial condensation polymer is put into an emulsification reactor of the wasabi oil that is previously prepared. Subsequently, temperature is increased up to 70 degrees while the rotating speed is maintained at 1200 rpm or more.

At this time, a sufficient stirring state should be maintained while preventing viscosity from increasing as reaction progresses. After about one hour, the homomixer is removed, the temperature is maintained using a common stirrer, the rotating speed is maintained at 500 to 1000 rpm, and the stirring operation is continued for five hours or more.

Subsequently, the heating operation is stopped and 30 g of 5% citric acid solution is gradually added. Stirring is continued until the temperature reaches room temperature.

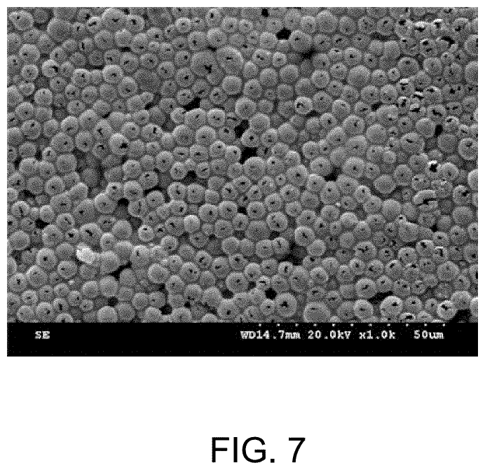

The wasabi oil microcapsule (see FIG. 7) produced as such is stored and used.

2. Mixing Process

30% of water-repellent-agent microcapsule, 5% of wasabi microcapsule, 10% of fluorine-based water-repellent agent, 50% of aqueous acryl binder, 0.2% of penetrant, and water are added and thoroughly mixed. Here, the amount of the water-repellent-agent microcapsule may be appropriately adjusted in the range of 10 to 40%.

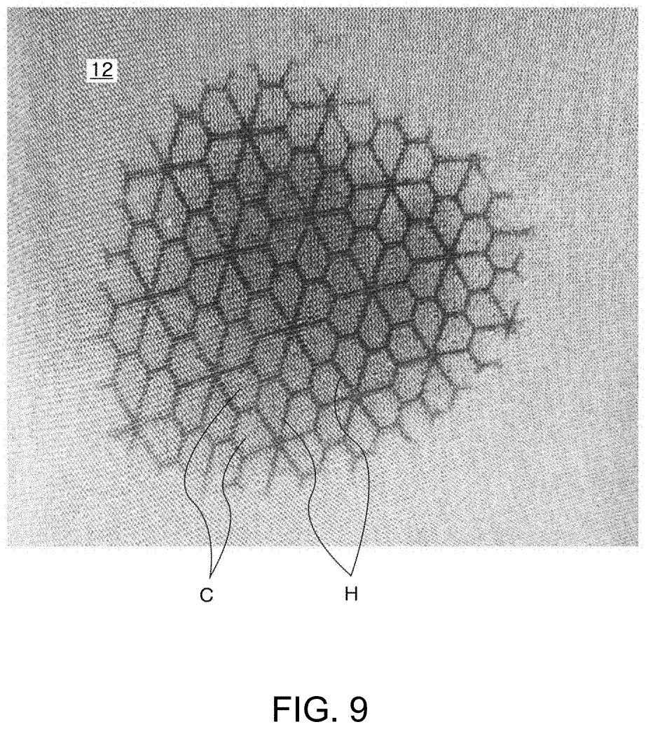

The composition obtained by such a process is coated onto the fabric and then dried, so that the inner covering fabric 12 (see FIG. 5) having the sweat-absorbing and quick-drying function and the antibacterial and deodorizing function is obtained. Here, the coating method may use screen printing, gravure coating, etc. However, any coating method may be used as long as a predetermined pattern is formed on fiber. Preferably, coating is possibly performed while neighboring patterns (i.e. coating cells) are spaced apart from each other by a predetermined distance of about 0.5 to 1 mm (i.e. uncoating channel) (see FIG. 9). After the coating has been performed, a drying operation is sufficiently performed using a tenter or a dryer.

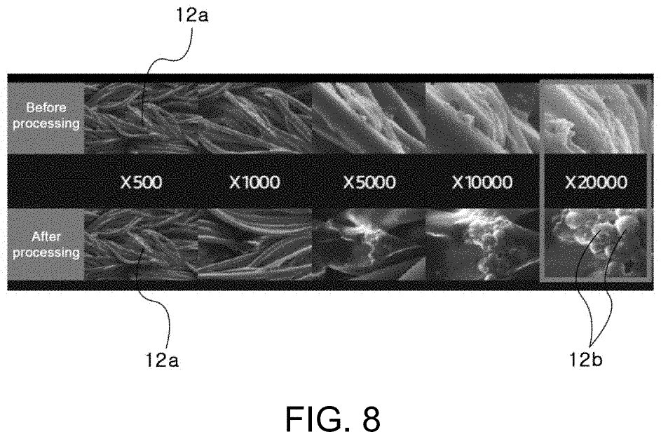

As shown in a lower row of FIG. 8 that is an enlarged view of fiber forming the inner covering fabric 12 obtained through such a fiber treatment process, it can be seen that the water-repellent-agent microcapsule or the wasabi microcapsule 12b is coated onto the fiber 12a, as described above. This is different from the fiber 12a of an upper row that is not subjected to the process.

FIG. 9 is an enlarged photograph of the inner covering fabric 12. When water (corresponding to sweat when wearing the mask) is sprinkled on the bottom of the inner covering fabric 12 coated with the above-described composition, as shown in the drawing, drainage or water-repellent action is made through a space that is not coated between coating surfaces that are coating cells C, namely, the uncoating channel H, thus allowing water to smoothly move to the top (opposite side).

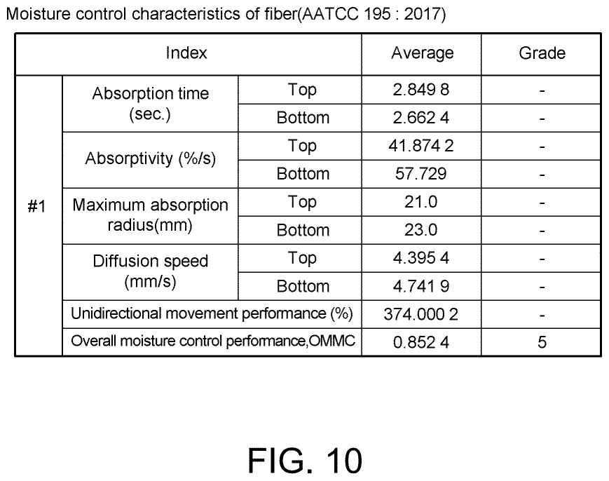

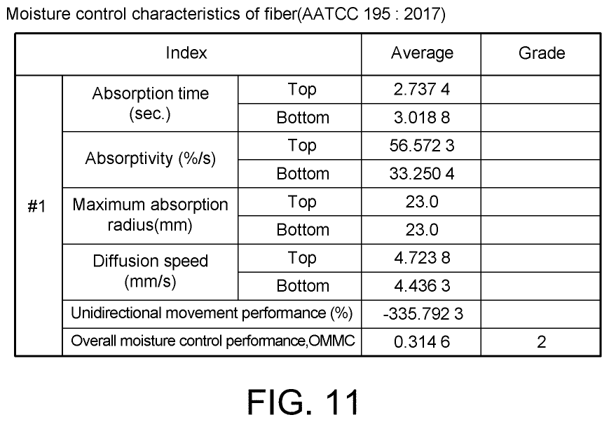

FIGS. 10 and 11 show antibacterial-activity test reports of the inner covering fabric 12 (see FIG. 9). As shown in FIG. 10, it can be seen that the water-repellent performance from the bottom coated with the sweat-absorbing and quick-drying antibacterial composition to the top is excellent as Grade 5. In contrast, as shown in FIG. 11, it can be seen that the water-repellent performance from the top to the bottom is as poor as Grade 2. In other words, it can be seen that the inner covering fabric 12 has unidirectional sweat-absorbing and quick-drying performance.

By this principle, secretions or saliva generated when a mask wearer sneezes, or water accumulated in the mask due to repeated breathing can be rapidly discharged to the front, thus keeping wearing environment fresh.

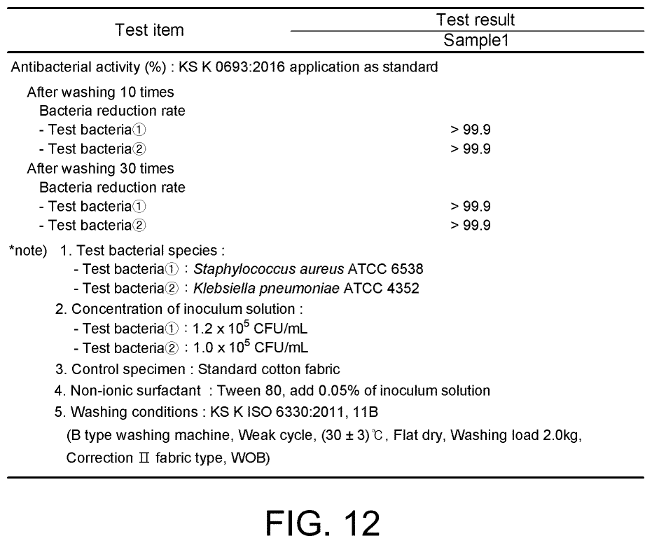

FIG. 12 shows an antibacterial-activity test report of the inner covering fabric 12 (see FIG. 9). As shown in the drawing, it can be seen that the antibacterial performance is continuously maintained at 99.9% or more after the fabric is washed 10 to 30 times. The wasabi oil in the capsule is artificially discharged by lightly rubbing the inner covering fabric 12 by hand, thus restoring or improving the antibacterial and deodorizing function.

Meanwhile, although only the micro-encapsulation of the wasabi oil has been described to provide the antibacterial and deodorizing function, the present invention is not limited thereto but another material having the antibacterial and deodorizing function may be replaced or added. For example, a phytoncide microcapsule obtained by micro-encapsulating oil that contains a phytoncide component helping to strengthen an antibacterial function, immunity, and a cardiorespiratory function in the above-mentioned method may be additionally used. In this case, the content of the wasabi microcapsule in the above-mentioned section “2. Mixing process” may be reduced from 5% to 2-3%, and the phytoncide microcapsule may be added by 2 to 3%.

Moreover, by micro-encapsulating oil in which vitamin C or chitosan effective for skin care is dissolved as the functional microcapsule, the skin care microcapsule such as a vitamin C microcapsule or a chitosan microcapsule may be made to be replaced with or added to the antibacterial and deodorizing microcapsule. For example, the wasabi microcapsule in the above-mentioned section “2. Mixing process” may be adjusted to 2 to 3%, and the skin care microcapsule may be added by 2 to 3%.

Although the present invention was described with reference to specific embodiments shown in the drawings, it is apparent to those skilled in the art that the present invention may be changed and modified in various ways without departing from the scope of the present invention, which is described in the following claims.

What is claimed is:

1. A smart mask, comprising:
an outer covering fabric of a three-ply fabric structure including an outside fabric, an inside fabric, and an intermediate fabric intersecting and knitting between the outside fabric and the inside fabric; and
an inner covering fabric obtained by coating and drying a composition on a first surface thereof, the composition containing a water-repellent agent for fiber, a functional microcapsule obtained by micro-encapsulating functional oil that has antibacterial and deodorizing effects or skin care effects, and an aqueous binder for processing a fabric, the inner covering fabric being joined to the outer covering fabric by attaching a second surface of the inner covering fabric to a surface of the inside fabric.

2. The smart mask of claim 1, wherein the intermediate fabric comprises a first intermediate fabric and a second intermediate fabric that intersect with each other in a zigzag fashion to be knitted between the outside fabric and the inside fabric.

3. The smart mask of claim 1, wherein all of the outside fabric, the inside fabric, and the intermediate fabric of the outer covering fabric are formed of synthetic microfiber, and
the inner covering fabric is formed of natural microfiber.

4. The smart mask of claim 3, wherein the natural fiber is Tencel™ or rayon.

5. The smart mask of claim 1, wherein the functional microcapsule comprises a phytoncide microcapsule obtained by micro-encapsulating phytoncide oil, a wasabi microcapsule obtained by micro-encapsulating wasabi oil, and a skin care microcapsule obtained by micro-encapsulating oil in which a component effective for skin care is dissolved.

6. The smart mask of claim 5, wherein the functional microcapsule essentially comprises at least one of the phytoncide microcapsule and the wasabi microcapsule.

7. The smart mask of claim 1, wherein an uncoating channel of a predetermined width is formed on a surface of the inner covering fabric to define a boundary between neighboring coating cells that are distributed on a plane due to coating and drying treatment of the composition, so that each of the coating cells forms a water repellent part and the uncoating channel forms a water absorbing part.
